(19) United States
(12) Patent Application Publication
(10) Pub. No.: US 2015/0362105 A1
(43) Pub. Date: Dec. 17, 2015

(54) GASKET-INTEGRATED CERAMIC ORIFICE PLATE

(71) Applicant: FUJIKIN INCORPORATED, Osaka-shi, Osaka (JP)

(72) Inventors: Masaaki NAGASE, Osaka-shi (JP); Ryousuke DOHI, Osaka-shi (JP); Nobukazu IKEDA, Osaka-shi (JP); Kouji NISHINO, Osaka-shi (JP)

(73) Assignee: FUJIKIN INCORPORATED, Osaka (JP)

(21) Appl. No.: 14/763,713

(22) PCT Filed: Jan. 24, 2014
(86) PCT No.: PCT/JP2014/000350

§ 371 Date: Jul. 27, 2015

(30) Foreign Application Priority Data
Feb. 1, 2013 (JP) 2013-018039

(51) Int. Cl. F16L 21/02

(52) U.S. Cl. CPC F16L 21/02

(57) ABSTRACT

Gasket-integrated orifice plates including a first orifice base (2) that includes a fitting protrusion (2b) and that is provided with a penetrating passage (2a) at a center thereof, and a second orifice base (3) that includes a fitting recess (3b) and that is provided with a penetrating passage (3a) at a center thereof that communicates with the passage (2a) of the first orifice base (2) are fit together with a ceramic orifice plate (4) being airtightly inserted and fixed between end faces of the both orifice bases (2, 3) and external end faces of the both orifice bases (2, 3) being made to be gasket sealing faces (2c, 3c).

### FIELD OF THE INVENTION

The present invention relates to improvements in gasket-integrated orifice plates used in flow rate control systems or the like. More particularly, the present invention relates to a high corrosion-resistance gasket-integrated ceramic orifice plate that includes an orifice plate with a precisely sized orifice and that is made of a thin ceramic plate instead of an orifice plate made of a thin metal plate.

### BACKGROUND OF THE INVENTION

Orifice plates that have been conventionally used are made by drilling an orifice to a thin metal plate by metal machining or the like and that are inserted and fixed by fastening to a proper position in a joint member of piping or in a connecting part between a device and a pipe. However, a thickness of the thin metal plate used for the orifice plate of this kind which is fastened and directly fixed in the manner described above may not be drastically reduced because the thin metal plate can deform when fastened and fixed. Therefore it is a problem that a plate which is thin enough to easily prepare an orifice plate that has an orifice with a desired shape and diameter dimension for a precise flow characteristic may not be used.

The applicant has previously developed and disclosed a gasket-integrated orifice plate that has an extremely thin metal plate with a thickness of 500 to 1000 μm airtightly clamped and fixed between internal end faces of an orifice base with a fitting protrusion and an orifice base with a fitting recess with external end faces of the both orifice bases made to be sealing faces of the gasket. (Japanese Unexamined Patent Application Publication No. 2007-057474, Japanese Unexamined Patent Application Publication No. 2010-151698).

FIGS. 16 to 18 show an embodiment of the gasket-integrated orifice plate 38 which includes the extremely thin metal plate, and in the embodiment, an orifice base 38a with a fitting protrusion 38a₁ and an orifice base 38b with a fitting recess 38b₁ are fit together with an orifice plate 38c made of a thin metal plate airtightly clamped and fixed between internal end faces of the both orifice bases, and both end faces 38a₃ and 38b₃, or 38a₄ and 38b₄ of the both orifice bases 38a and 38b made to be sealing faces of the gasket.

In FIG. 18, an outer diameter dimension of the orifice base 38b that has the fitting recess 38b₁ is configured to be larger than an outer diameter dimension of the orifice base 38a that has the fitting protrusion 38a₁ with an internal end face 38d of an outer circumferential part of the orifice base 38b also made to be a sealing face.

In other words, airtightness of the gasket-integrated orifice plate 38 is maintained by the each sealing face 38a₃, 38b₃, and 38d by inserting the gasket-integrated orifice plate 38 into an orifice housing recess 7c that is formed on an end face at a downstream-side of a valve body 7 to press and fix an outlet-side block 10 to the valve body 7. Here, in FIG. 18, reference symbols 7d, 7e, and 10d designate annular protrusions that enhance sealing property of the each sealing face by biting thereto.

In the gasket-integrated orifice plate 38 shown in FIGS. 16 and 18, the orifice plate 38c is airtightly fit and clamped between the both orifice bases 38a and 38b. Therefore, even an extremely thin metal plate or metal film may be clamped and held between the both orifice bases 38a and 38b without causing problems such as deformation. Thus, usage of the orifice plate 38c with a precisely made orifice becomes possible, and the gasket-integrated orifice plate 38 itself may be closely fastened and fixed to a pipe or the like as a gasket by using the external end faces of the both orifice bases as the sealing faces to achieve superior practical effect.

Additionally, because the gasket-integrated orifice plate 38 shown in FIG. 18 has the external end face 38a₃ of the projected orifice base 38a and the external end face 38b₃ as well as the outer circumferential part 38d of the internal end face of the recessed orifice base 38b as the sealing faces, the gasket-integrated orifice plate may be closely fastened and fixed in a liquid flow passage, and enhanced sealing property may be achieved by the sealing faces at 3 positions. Also, there are more advantages such as perfect prevention of leakage from the sealing part of the orifice plate 38c to the outside which is achieved by the sealing face 38d.

As described above, the gasket-integrated orifice plate 38 shown in FIGS. 16 to 18 has great usefulness, though it still has many issues left to be solved. One of the most urgent tasks is to prevent fluctuation of a flow characteristic due to deformation of the orifice caused by corrosion of the metal orifice plate 38c.

In other words, for the gasket-integrated orifice plate 38, an extremely thin metal plate with a thickness of 30 to 1000 μm (for example, SUS316L-P (double melt), NK Clean Z with little impurity content or the like) is used for enhanced preciseness of a diameter dimension and/or shape of the orifice to obtain a circle-shaped hole with an inner diameter of 10 to 500 μm. Therefore, the orifice plate 38c is relatively easily corroded or eroded by a flow of contacting liquid. Especially, in case the contacting liquid is a corrosive gas such as ozone-contained gas, chlorine-contained gas, or hydrogen bromide-contained gas, the diameter dimension and/or shape of the orifice changes greatly, and when the gasket-integrated orifice plate 38 is used in a flow rate control system or the like, troubles such as significant decrease in flow rate control accuracy are caused.

Consequently, higher changing frequency of the gasket-integrated orifice plate 38 requires more trouble and results in higher repair cost.

### CITATION LIST

### Patent Literature

Patent document 1: Japanese Unexamined Patent Application Publication No. 2007-057474
Patent document 2: Japanese Unexamined Patent Application Publication No. 2010-151698

### SUMMARY OF THE INVENTION

### Technical Problems

The present invention is for solving the above problems in conventional gasket-integrated orifice plates such as (i) relatively low corrosion resistance that greatly increases changing frequency of the gasket-integrated orifice plate when used with a corrosive liquid and also inhibits precise flow rate control when used in a flow rate control system or the like which is caused by an extremely thin metal orifice plate used to form an orifice with a predetermined diameter dimension as well as a shape for a stable flow characteristic and (ii) higher repair cost due to more frequent replacement of the gasket-integrated orifice plate, and it is a main object of the present invention to provide a gasket-integrated orifice plate including a ceramic orifice plate instead of the thin-metal orifice plate for greatly enhanced corrosion resistance for a highly precise and stable flow characteristic, for easy insertion and fixation in a liquid flow passage without leakage, and for a lower production cost.

### Solution to the Problems

For achieving the above objects, in a first aspect of a gasket-integrated ceramic orifice plate of the present invention, a first orifice base that has a fitting protrusion and that is provided with a penetrating passage at a center thereof and a second orifice base that has a fitting recess and that is provided with a penetrating passage at a center thereof that communicates with the passage of the first orifice base are fit together with a ceramic orifice plate airtightly inserted and fixed between end faces of the first orifice base and the second orifice base, and respective external end faces of the first and second orifice bases made to be sealing faces of the gasket.

One of the first and second orifice bases may be configured to have a larger outer diameter than an outer diameter of the other orifice base, and an outer circumferential edge of an internal end face of the orifice base with the larger outer diameter may be a sealing face.

The ceramic orifice plate may be configured to have an orifice at a center thereof that communicates with the passage of the first orifice base as well as the passage of the second orifice base and to be airtightly inserted and fixed between the fitting protrusion of the first orifice base and the fitting recess of the second orifice base.

The ceramic orifice plate may be made of zirconia-contained ceramic, and a thickness thereof may be 500 to 1000 μm and a diameter dimension of the orifice may be 10 to 500 μm. Also, the fitting protrusion may be pressed into the fitting recess with a press fitting force of 6 to 10 kN to airtightly insert and fix the ceramic orifice plate between the fitting protrusion and the fitting recess.

Both sides of the circle-shaped ceramic orifice plate may be mirror-polished and contacting faces of the fitting protrusion as well as the fitting recess that abut the ceramic orifice plate may be mirror-polished as well.

In a second aspect, a gasket-integrated ceramic orifice plate of the present invention includes a first orifice base that has a fitting protrusion and that is provided with a penetrating passage at a center thereof, a second orifice base that has a fitting recess and that is provided with a penetrating passage at a center thereof, a middle orifice base that is provided with a penetrating passage at a center thereof that communicates with the passages of the first and second orifice bases and that has a fitting recess on an end face in which the fitting protrusion of the first orifice base is airtightly fit as well as a fitting protrusion on another end face to which the fitting recess of the second orifice base is airtightly fit, a first ceramic orifice plate that is airtightly inserted and fixed between the first orifice base and the middle orifice base and that has an orifice formed at a center thereof, and a second ceramic orifice plate that is airtightly inserted and fixed between the middle orifice base and the second orifice base and that has an orifice formed at a center thereof. Also, the gasket-integrated ceramic orifice plate is provided in a liquid flow passage with external end faces of the first and second orifice bases made to be sealing faces, and an outer diameter dimension of one of the first and second orifice bases is configured to be larger than an outer diameter dimension of the other orifice base and that of the middle orifice base with an outer circumferential edge of an internal end face of the orifice base with the larger outer diameter made to be a sealing face. There is also a divided flow passage 5d formed on the middle orifice base that communicates with the passage of the middle orifice base.

The second ceramic orifice plate may be configured to have an orifice at a center thereof that communicates with the passage of the first orifice base as well as the passage of the middle orifice base and to be airtightly inserted and fixed between the fitting protrusion of the first orifice base and the fitting recess of the middle orifice base.

The second ceramic orifice plate may be configured to have an orifice at a center thereof that communicates with the passage of the middle orifice base as well as the passage of the second orifice base and to be airtightly inserted and fixed between the fitting protrusion of the middle orifice base and the fitting recess of the recessed second orifice base.

The first ceramic orifice plate may be made of zirconia-contained ceramic, and a thickness thereof may be 500 to 1000 μm and a diameter dimension of the orifice may be 10 to 500 μm. The fitting protrusion of the first orifice base may be pressed into the fitting recess of the second orifice base with a press fitting force of 6 to 10 kN to airtightly insert and fix the first ceramic orifice plate between the fitting protrusion of the first orifice base and the fitting recess of the middle orifice base.

The second ceramic orifice plate is made of zirconia-contained ceramic, and a thickness thereof is 500 to 1000 μm and a diameter dimension of the orifice is 10 to 500 μm. The fitting protrusion of the middle orifice base is pressed into the fitting recess of the second orifice base with a press fitting force of 6 to 10 kN to airtightly insert and fix the second ceramic orifice plate between the fitting protrusion of the middle orifice base and the fitting recess of the second orifice base.

In the second aspect of the present invention, a diameter dimension of the orifice of one of the first or second orifice plates that positions at an upstream-side may be configured to be smaller than a diameter dimension of the orifice of the orifice plate that positions at a downstream-side.

In the second aspect of the present invention, both sides of the first and second circle-shaped ceramic orifice plates may be mirror-polished and contacting faces of the fitting protrusion of the first orifice base and the fitting recess of the second orifice base that abut the first and second ceramic orifice plates may be mirror-polished as well.

Furthermore, in a third aspect, a gasket-integrated orifice plate of the present invention includes a third orifice base that has fitting recesses on both side faces thereof and that is provided with a penetrating passage at a center thereof, fourth and fifth orifice bases that respectively have a fitting protrusion, that are respectively provided with a penetrating passage at a center thereof, and that are respectively inserted into the each fitting recess opposingly, and a ceramic orifice plate that is arranged in the passage of the third orifice base. Here, the ceramic orifice plate arranged in the passage of the third orifice base is airtightly clamped and fixed between tip faces of the fourth and fifth orifice bases that are pressed into the fitting recesses, and external end faces of the fourth and fifth orifice bases are made to be sealing faces of the gasket.

In the third aspect of the present invention, annular protrusions may be formed on outer circumferential faces as well as on tip faces of the fitting protrusions of the fourth and fifth orifice bases to enhance airtightness between the fitting protrusions and the fitting recesses by the annular protrusions on the outer circumferential faces of the fitting protrusions and to enhance airtightness between the fitting protrusions and the ceramic orifice plates by the annular protrusions on the tip faces of the fitting protrusions.

In the third aspect of the present invention, the ceramic orifice plate may be configured to be thick disk-shaped and to be made of zirconia-contained ceramic, and the both fitting protrusions may be pressed into the both fitting recesses with a press fitting force of 6 to 10 kN to airtightly insert and fix the ceramic orifice plate between the tip faces of the both fitting protrusions.

### Advantageous Effects of the Invention

In a first aspect of the invention, a gasket-integrated ceramic orifice plate is formed by airtightly fitting a ceramic orifice plate between a first orifice base and a second orifice base. As a result, corrosion resistance of the ceramic orifice plate may be greatly improved, and even an extremely thin ceramic orifice plate may be clipped between the both orifice bases without causing troubles such as deformation for preparing the gasket-integrated ceramic orifice plate with a precisely shaped orifice. Also, the orifice bases may be closely fastened and fixed as gaskets to a pipe or the like by using external end faces of the first and second orifice bases, or the external end faces of the first and second orifice bases as well as an outer circumferential part of an internal end face of one of the first or second orifice bases as sealing faces.

Also in one embodiment of the first aspect of the present invention, a ceramic orifice plate with a thickness of 500 to 1000 μm that has an orifice with a diameter of 10 to 500 μm is inserted and fit between a fitting protrusion of the first orifice base and a fitting recess of the second orifice base, and the fitting protrusion is pressed into the fitting recess with a press fitting force of 6 to 10 kN to airtightly insert and fix the ceramic orifice plate between them with both sides of the ceramic orifice plate as well as contacting faces of the fitting protrusion and the fitting recess that abut the ceramic orifice plate respectively finished to mirror-polished. As a result, a high corrosion-resistance gasket-integrated ceramic orifice plate with a precisely made orifice may be easily prepared, and a gasket-integrated ceramic orifice plate with substantially no leakages at contact faces between the ceramic orifice plate and the fitting protrusion or the fitting recess and/or a contact face between the fitting protrusion and the fitting recess also becomes possible to be prepared.

Furthermore, in a second aspect of the present invention, a middle orifice base that has a fitting recess on an end face that fits to a fitting protrusion of a first orifice base and a fitting protrusion on another end face that fits to a fitting recess of a second orifice base is provided between the first and second orifice bases with a first ceramic orifice plate provided between the fitting protrusion of the first orifice base and the fitting recess of the middle orifice base and a second ceramic orifice plate provided between the fitting recess of the second orifice base and the fitting protrusion of the middle orifice base. A divided flow passage that communicates with a passage of the middle orifice base is also formed. As a result, a gasket-integrated ceramic orifice plate with a plurality of flow characteristics may be prepared by differing diameter dimensions of orifices of the first ceramic orifice plate and the second ceramic orifice plate from each other as well as by controlling liquid supply to the passage.

In a third aspect of the present invention, a gasket-integrated ceramic orifice plate includes a third orifice base that has fitting recesses on both sides thereof and that is provided with a penetrating passage at a center thereof, a fourth and fifth orifice bases that respectively have a fitting protrusion, that are respectively provided with a penetrating passage at a center thereof, and that are respectively inserted into the each fitting recess opposingly, and a ceramic orifice plate that is fit in the passage of the third orifice base. The configuration therefore allows the gasket-integrated ceramic orifice plate to be consisted of two kinds of members with a relatively thick ceramic plate, and simplification of a structure as well as reduction of manufacturing cost become possible.

Additionally, when the gasket-integrated ceramic orifice plate of the present invention is used in a pressure-type flow rate control system or the like, exchange of the orifice plate may be conducted very easily, and securing of airtightness as well as prevention of deformation at a time of installing the orifice plate are almost perfectly achieved. Also, a highly precise flow rate control may be realized because the ceramic orifice plate has high corrosion resistance.

### BRIEF DESCRIPTION OF THE DRAWINGS

FIG. 1 A sectional view of a gasket-integrated ceramic orifice plate as a first embodiment according to the present invention;

FIG. 2 A sectional view of the gasket-integrated ceramic orifice plate in FIG. 1 illustrating a structure thereof before assembly;

FIG. 3 A sectional view of a gasket-integrated ceramic orifice plate as a second embodiment according to the present invention;

FIG. 4 A sectional view of the gasket-integrated ceramic orifice plate in FIG. 2 illustrating a structure thereof before assembly;

FIG. 5 A sectional view of a pressure-type flow rate control system with the gasket-integrated ceramic orifice plate in FIG. 2;

FIG. 6 A partial sectional view of a mounting part of the gasket-integrated ceramic orifice plate in FIG. 5;

FIG. 7A enlarged sectional views of a gasket-integrated ceramic orifice plate for leakage test;

FIG. 7B enlarged sectional views of a gasket-integrated ceramic orifice plate for leakage test;

FIG. 8 An explanatory drawing of a leakage testing tool;

FIG. 9 An enlarged photo showing a state of an end face of a fitting protrusion of an orifice base disassembled after the leakage test;

FIG. 10 An enlarged photo showing a state of a bottom face of a fitting recess of the orifice base disassembled after the leakage test;

FIG. 11 An enlarged photo showing a state of a surface of a ceramic orifice plate disassembled after the leakage test;

FIG. 12 An enlarged photo of pits on an unused ceramic orifice plate after mirror-polishing;

FIG. 13 An enlarged photo of a selected unused mirror-polished ceramic orifice plate without pits on surface;

FIG. 14 A sectional view of a gasket-integrated ceramic orifice plate as a third embodiment according to the present invention;

FIG. 15 A sectional view of the gasket-integrated ceramic orifice plate as the third embodiment illustrating a structure thereof before assembly;

FIG. 16 A sectional view of a conventional gasket-integrated orifice plate;

FIG. 17 A sectional view of the conventional gasket-integrated orifice plate before assembly;

FIG. 18 A sectional view of a conventional gasket-integrated orifice plate as another example.

### DESCRIPTION OF THE EMBODIMENTS

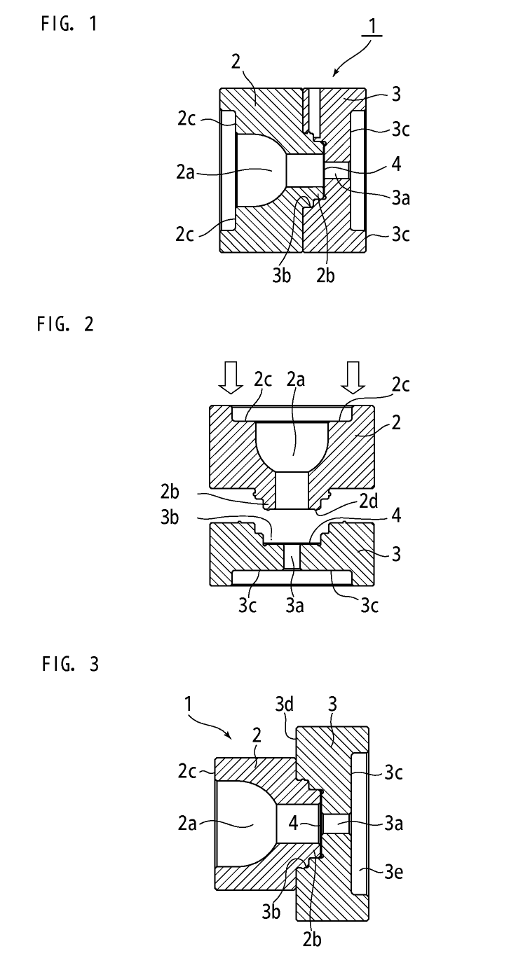

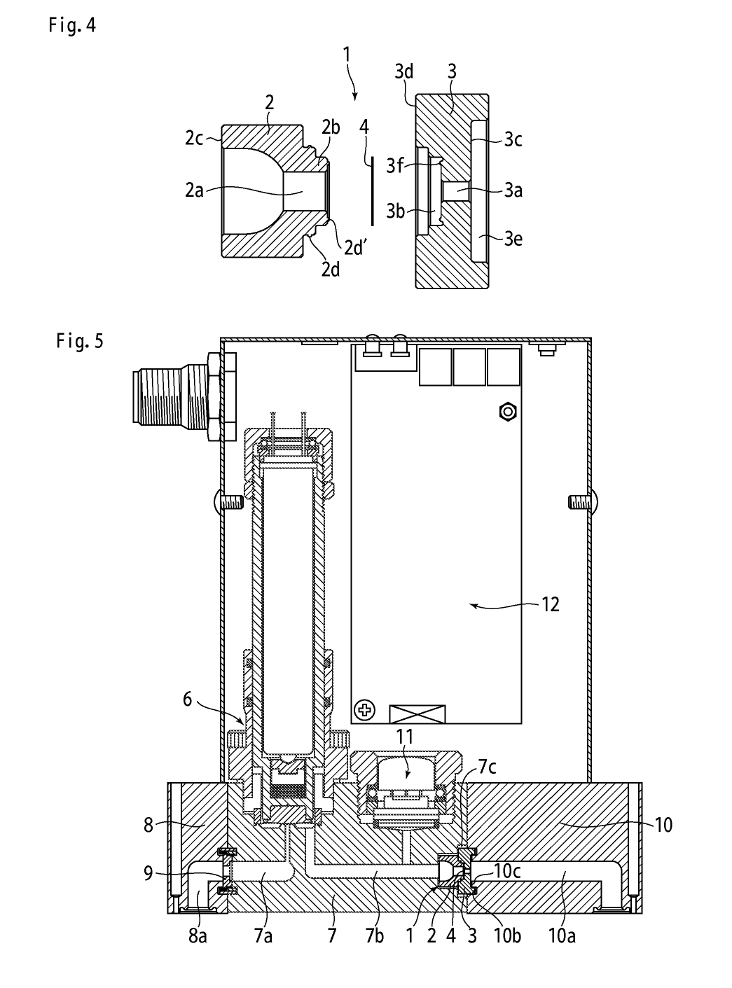

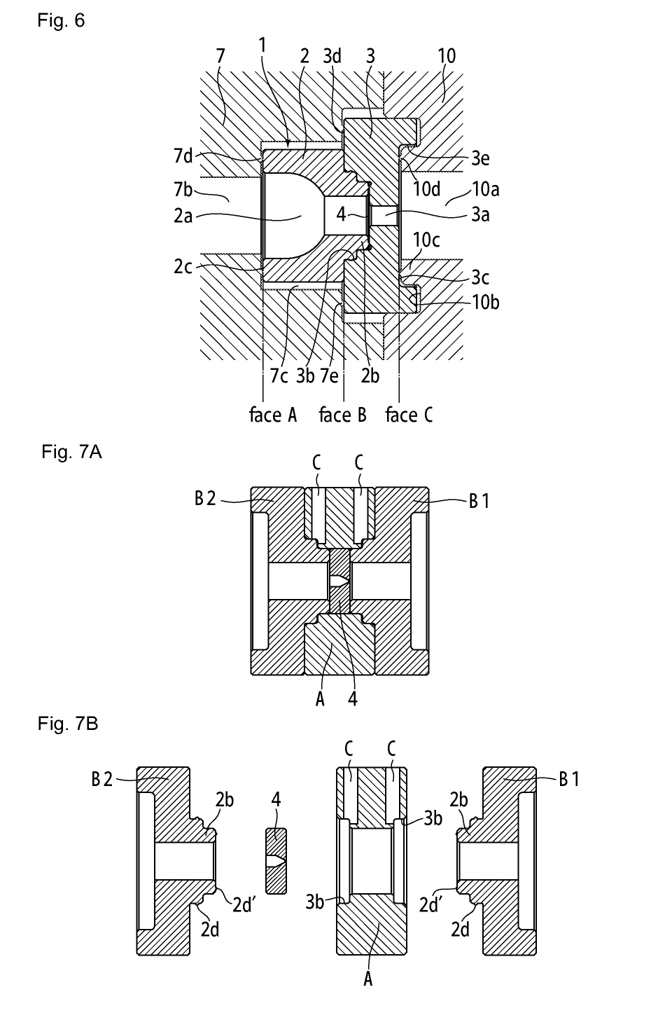

Hereinafter, referring to drawings, embodiments of the present invention will be explained in detail. FIGS. 1 and 2 illustrate a first embodiment of a gasket-integrated ceramic orifice plate according to the present invention. FIGS. 3 and 4 illustrate a second embodiment of the gasket-integrated ceramic orifice plate according to the present invention. Further, FIG. 5 illustrates a pressure-type flow rate control system with the gasket-integrated ceramic orifice plate in FIG. 3, and FIG. 6 is a partial enlarged view of an inserting part of the gasket-integrated ceramic orifice plate in FIG. 5.

Here, the only and slight difference between the gasket-integrated ceramic orifice plate 1 as the first embodiment shown in FIG. 1 and the gasket-integrated ceramic orifice plate 1 as the second embodiment shown in FIG. 3 is in shape of a second orifice base 3 at a downstream-side. Also, configurations of the gasket-integrated ceramic orifice plate 1 as the first embodiment shown in FIG. 1 as well as the gasket-integrated ceramic orifice plate 1 as the second embodiment shown in FIG. 3 are substantially the same as a configuration of a conventional gasket-integrated orifice plate shown in FIGS. 15 and 17 except that materials of orifice plates 4 are different. Therefore, an embodiment of the present invention is explained based on the gasket-integrated ceramic orifice plate 1 of the second embodiment shown in FIGS. 3 and 4.

As shown in FIGS. 1 to 4, the gasket-integrated ceramic orifice plate 1 includes a projected first orifice base 2 that is provided with a penetrating passage 2a at a center thereof and that has a fitting protrusion 2b on an internal end face thereof, a recessed second orifice base 3 with a larger diameter than that of the first orifice base 2 that is provided with a penetrating passage 3a at a center thereof and that has a fitting recess 3b on an internal end face thereof, and a ceramic orifice plate 4 with an orifice formed at a center thereof (not shown). Here, the projected first orifice base 2 and the recessed second orifice base 3 are fit together with the ceramic orifice plate 4 airtightly inserted and fixed between the both orifice bases 2 and 3, and both external end faces of the orifice bases 2 and 3 as well as the internal end face of the second orifice base 3 made to be sealing faces 2c, 3c, and 3d of the gasket-integrated orifice plate 1 for preventing leakages at sealing locations of the ceramic orifice plate 4.

Specifically, as shown in FIG. 4, the projected first orifice base 2 is made from stainless steel material (SUS316L-P (double melt)) and formed into a short cylindrical shape with a vertical cross section of a projecting shape, and the penetrating passage 2a with a stepped inner circumferential face is formed at the center thereof. Also, the cylindrical-shaped fitting protrusion 2b with a stepped outer circumferential face is projectingly formed concentrically with the passage 2a on an internal end face of the projected first orifice base 2 (an end face against the recessed second orifice 3). Here, annular protrusions 2d and 2d′ (refer to FIG. 4) that exert sealing property when the projected first orifice base 2 is combined with the recessed second orifice base 3 are respectively formed on an outer circumferential face of a larger-diameter side of the fitting protrusion 2b as well as on an end face of the fitting protrusion 2b. Further, the annularly-shaped external end face of the projected first orifice base 2 serves as the sealing face 2c of the gasket-integrated ceramic orifice plate 1.

As shown in FIG. 4, the recessed second orifice base 3 is made from stainless steel material (SUS316L-P (double melt)) and formed into a recessed thick disk-shape with a vertical cross section of a recessing shape, and the penetrating passage 3a that communicates with the passage 2a of the projected first orifice base 2 is formed at the center thereof. Also the fitting recess 3b in which the fitting protrusion 2b of the projected first orifice base 2 is airtightly fit is formed concentrically with the passage 3a on the internal end face of the recessed second orifice base 3 (an end face against the projected orifice base 2). An inner circumferential face of the fitting recess 3b is formed to have a stepped part so that the fitting protrusion 2b of the projected first orifice base 2 is airtightly fit thereto. Here, an annular protrusion 3f (refer to FIG. 4) that clips and holds the ceramic orifice plate 4 with the annular protrusion 2d′ of the first orifice base 2 therebetween to exerts sealing property when the recessed second orifice base 3 is combined with the projected first orifice base 2 is formed on an end face of the fitting recess 3b.

Furthermore, a circle-shaped recess 3e is further formed concentrically with the passage 3a on the external end face of the second orifice base 3 that has the fitting recess 3b for receiving the fitting protrusion 2b, and a bottom face of the recess 3e which is formed on the external end face of the recessed second orifice base 3 functions as the sealing face 3c of the gasket-integrated orifice plate 1. The recess 3e facilitates positioning (shaft alignment) of the gasket-integrated orifice plate 1 and protects the sealing face 3c.

Here, the bottom faces of the fitting protrusion 2b and the fitting recess 3b that abut a ceramic orifice plate 4 which is described later are so-called mirror-polished by electrolytic polishing or the like. In the second embodiment, an outer diameter dimension of the second orifice base 3 which is located at a downstream-side is configured to be larger than that of the first orifice base 2 which is located at an upstream-side so that an outer circumferential edge of the internal end face of the recessed second orifice base 3 located at the downstream-side functions as the sealing face 3d of the gasket-integrated orifice plate 1.

In the second embodiment, the outer diameter dimension of the recessed second orifice base 3 which is located at the downstream-side is configured to be larger than that of the projected first orifice base 2 which is located at the upstream-side so that the outer circumferential edge of the internal end face of the recessed second orifice base 3 functions as the sealing face 3d of the gasket-integrated orifice plate 1, though the outer diameter dimension of the second orifice 3 may be configured to be the same size as the outer diameter dimension of the first orifice base 2 to eliminate the sealing face 3d. The gasket-integrated ceramic orifice plate as the first embodiment shown in FIGS. 1 and 2 is configured in such a manner as above.

The ceramic orifice plate 4 that has an extremely thin circular-plate shape is formed from zirconia-contained ceramic and an orifice (not shown) with a desired inner diameter dimension that communicates with the passages 2a and 3a of the first orifice base 2 and the second orifice base 3 is provided at a center thereof. The ceramic orifice plate 4 is sized to be housed in a smaller-diameter part of the fitting recess 3b of the recessed second orifice base 3. Here, the ceramic orifice plate 4 is good in a form of a circle or any other shape.

In the first and second embodiments, a thickness of the ceramic orifice plate 4 is configured to be 500 to 1000 μm and a diameter dimension of the hole (the orifice) is configured to be 10 to 500 μm with both external surfaces thereof finished to mirror-polished by lapping-polishing or the like, and the fitting protrusion 2b is pressed into the fitting recess 3b with a press fitting force of 6 to 10 kN to clip and hold the ceramic orifice plate 4 between the fitting protrusion 2b and the fitting recess 3b.

Specifically, the gasket-integrated ceramic orifice plate is formed by housing the ceramic orifice plate 4 in the fitting recess 3b of the recessed second orifice base 3, and pressing the fitting protrusion 2b of the projected first orifice base 2 into the fitting recess 3b of the recessed second orifice base 3 with a presser that outputs a press fitting force of about 9 kN to airtightly integrate the both orifice bases 2 and 3. At that time, the outer circumferential face of the fitting protrusion 2b airtightly fits to the inner circumferential face of the fitting recess 3b, and the both surfaces of the ceramic orifice plate 4 are clamped and held between the annular protrusion 2d′ of the first orifice base 2 and the annular protrusion 3f of the second orifice base 3 to secure better sealing property. The annular protrusion 2d on the outer circumferential face of the orifice base 2 further helps the orifice plate 4 fits even more airtightly.

FIG. 5 shows a case where the gasket-integrated ceramic orifice plate 1 according to the second embodiment is applied in a pressure-type flow rate control system. Here, the pressure-type flow rate control system includes a piezoelectric element driving-type control valve 6, an inlet-side block 8 which is fastened and fixed to an upstream-side of a body 7 of the control valve 6 with a bolt (not shown) to form an inlet-side flow passage 8a that communicates with a flow passage 7a at the upstream-side of a body 7, a gasket-type filter 9 which is interposed between the body 7 and the inlet-side block 8 for sealing therebetween, an outlet-side block 10 which is fastened and fixed to a downstream-side of the body 7 of the control valve 6 with a bolt (not shown) to form an outlet-side flow passage 10a that communicates with a flow passage 7b at the downstream-side of the body 7, the gasket-integrated ceramic orifice plate 1 which is interposed between the body 7 and the outlet-side block 10 for sealing therebetween, a pressure sensor 11 which is provided to the body 7 of the control valve 6 for detecting a pressure at an upstream-side of the gasket-integrated ceramic orifice plate 1, and a control circuit 12 for controlling the control valve 6, and controls a flow rate of liquid passing through the orifice of the ceramic orifice plate by controlling an opening degree of the control valve 6 based on a flow rate of the liquid flow passing through the orifice which is calculated from the pressure value at the upstream-side of the gasket-integrated ceramic orifice plate 1. Since the pressure-type flow rate control system shown in FIG. 5 is known, detailed description about the system is omitted here.

The gasket-integrated ceramic orifice plate 1 is housed in an orifice housing recesses 7c and 10b that are respectively formed on a downstream-side end face of the body 7 of the control valve 6 and on an upstream-side end face of the outlet-side block 10, and the gasket-integrated ceramic orifice plate 1 is airtightly fit and fixed in the orifice housing recesses 7c and 10b by fastening the body 7 and the outlet-side block 10 to fix them together.

In other words, as shown in FIG. 6, the orifice housing recess 7c on the downstream-side end face of the body 7 is formed in a recess with a stepped part where an inner diameter dimension changes, and an annular protrusion 7d that airtightly bites to seal the sealing face 2c on the external end face of the first orifice base 2 is formed on a bottom face of the orifice housing recess 7c with a smaller diameter. An annular protrusion 7e that airtightly bites to seal the sealing face 3d on the internal end face of the second orifice base 3 is also formed on a bottom face of the orifice housing recess 7c with a larger diameter.

The orifice housing recess 10b provided on the upstream-side end face of the outlet-side block 10 is formed in an annular recess around an inlet of the outlet-side flow passage 10a, and an annular gasket holding protrusion 10c that is inserted into the circle-shaped recess 3e on the recessed second orifice base 3 is formed on a bottom face of the orifice housing recess 10b. Here, an annular protrusion 10d that airtightly bites to seal the sealing face 3c on the external end face of the recessed second orifice base 3 is formed on an end face of the gasket holding protrusion 10c, and positioning of the gasket-integrated ceramic orifice plate 1 is easily conducted by inserting the gasket holding protrusion 10c into the recess 3e of the recessed second orifice base 3.

In FIG. 6, a distance between the sealing face 2c of the first orifice base 2 and the sealing face 3c of the second orifice base 3, a distance between the sealing face 2c of the first orifice base 2 and the sealing face 3d of the second orifice base 3, a distance between the sealing faces 3c and 3d of the orifice base 3, depths to the bottom face with the smaller diameter as well as to the bottom face with the larger diameter of the orifice housing recess 7c of the body 7, a height of the gasket holding protrusion 10c on the bottom face of the orifice housing recess 10b or the like are all configured to make a face A, as indicated in FIG. 6, firstly contacts to seal and then a face B subsequently contacts to seal when the body 7 and the outlet-side block 10 are fastened and fixed together with bolts. Here, the face A and the ceramic orifice plate 4 are respectively configured to keep a rate of leakage therefrom not higher than 1×10⁴ Pa·m³/sec and the face B as well as a face C are respectively configured to keep a rate of leakage therefrom, which turns to external leakage, not higher than 1×10⁻¹⁰ Pa·m³/sec.

[Leakage Test]

A gasket-integrated ceramic orifice plate as shown in FIG. 7A was firstly prepared as a gasket-integrated ceramic orifice plate 1 for leakage test for mainly investigating characteristics of leakages occur between metal end faces such as between a ceramic orifice plate 4 and a fitting protrusion 2b.

In other words, as shown in FIG. 7B, the gasket-integrated ceramic orifice plate for testing is formed by combining and integrating a fourth orifice base B1 as well as a fifth orifice base B2 that respectively have a fitting protrusion 2b, a third orifice base A with fitting recesses 3b on both sides thereof, and a ceramic orifice plate 4. Specifically, the fitting protrusions 2b and 2b of the fourth and fifth orifice bases B1 and B2 are pressed into the fitting recesses 3b and 3b on the both sides of the third orifice base A to clamp both sides of the ceramic orifice plate 4 between the fitting protrusions 2b and 2b and to airtightly fit outer circumferential faces of the fitting protrusions 2b and 2b to inner circumferential faces of the fitting recesses 3b and 3b respectively.

In FIG. 7A and FIG. 7B, reference symbol C designates a leakage detecting hole, and a total length between both outer surfaces of the orifice plate for testing is configured to be 8.8 mm, a diameter dimension of the orifice base is configured to be 10 mm, a diameter dimension of the ceramic orifice plate 4 is configured to be 3.5 mm, a thickness of the ceramic orifice plate 4 is configured to be 1.5 mm, and a diameter dimension of the orifice is configured to be 100 μm. Here, reference symbols 2d and 2d′ in FIG. 7A and FIG. 7B designate annular protrusions formed on the outer circumferential faces of the fitting protrusions 2b, and when the fitting protrusion 2b is inserted to the fitting recess 3b, the annular protrusion 2d′ functions to enhance airtightness between the outer circumferential face of the fitting protrusion 2b and the inner circumferential face of the fitting recess 3b, and the annular protrusion 2d′ functions to enhance airtightness between the end face of the fitting protrusion 2b and the side face of the ceramic orifice plate 4, respectively.

Further, in regards to preparation of the gasket-integrated ceramic orifice plate for leakage test shown in FIG. 7A and FIG. 7B, forms of the fitting protrusions 2b of the fourth and fifth orifice bases B1 and B2 as well as the fitting recesses 3b of the third orifice base A were the same as those in all cases shown in FIGS. 1 to 4. There were 3 types of the gasket-integrated ceramic orifice plates prepared for testing for various thrust forces of 7 kN, 8 kN, and 9 kN with which the fitting protrusions 2b were pressed into the fitting recesses 3b.

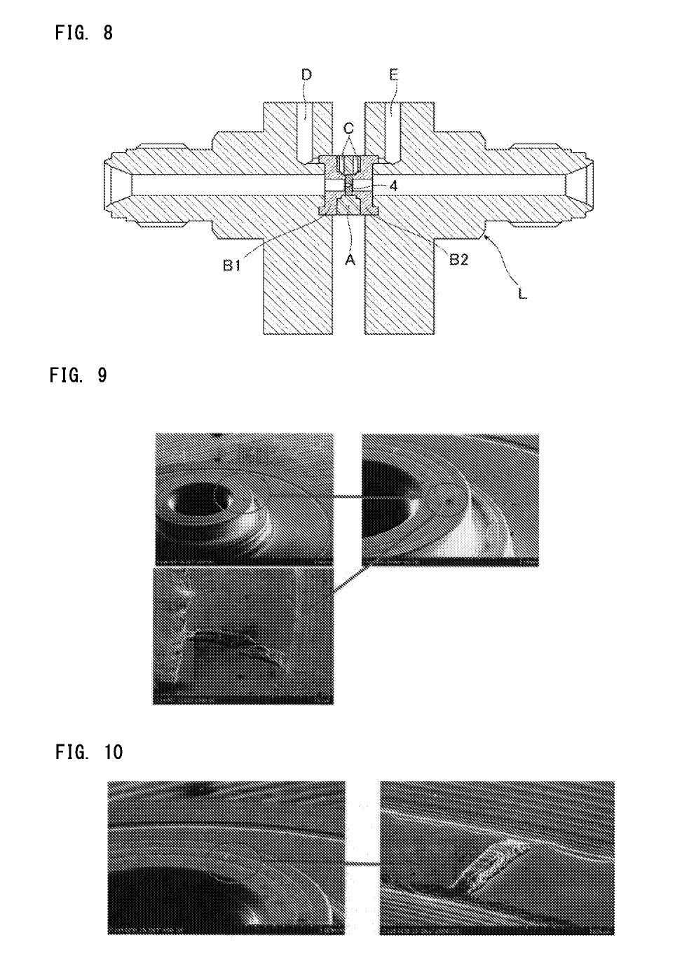

Then, as shown in FIG. 8, the gasket-integrated ceramic orifice plate for leakage test was set to a leakage testing tool L, and bolt tightening torque putting to the gasket-integrated ceramic orifice plates for leakage test was altered to measure leakage levels at the each leakage detecting hole at the each bolt tightening torque.

According to results of the leakage test shown in Table 1, the gasket-integrated ceramic orifice plates used for the leakage test turned out to be not suitable for practical use since the leakage levels stayed within a range between about 10⁻⁵ Pa·m³/sec and 10⁻⁵ Pa·m³/sec even the bolt tightening torque (kgf·cm) was increased, and the leakage levels of the gasket-integrated ceramic orifice plate for leakage test were inconsistent. Here, in terms of surface roughness, inner and outer surfaces as well as end faces that abut the ceramic orifice plate 4 of the fitting protrusions 2b of the orifice bases B and the fitting recesses 3b of the orifice base A were polished to a level of mirror-polished by processing machining, and surfaces of the ceramic orifice plate 4 were also polished to the level of mirror-polished by precision polishing.

TABLE 1

| | Press | Bolt tightening torque [kgf · cm] | | | | | | | | |
|---|---|---|---|---|---|---|---|---|---|---|
| Test | fitting | 10 | | | 15 | | | 20 | | |
| sample | force | A | B | C | A | B | C | A | B | C |
| NO. 1 | 7 kN | 7.6E−6 | 7.6E−6 | 7.6E−6 | 3.2E−6 | 8.1E−6 | 3.7E−6 | 1.7E−6 | 0.8E−6 | 2.8E−6 |
| NO. 2 | 8 kN | 6.1E−5 | — | — | 4.1E−5 | — | — | 5.6E−8 | 5.6E−5 | 1E−8 |
| NO. 3 | 9 kN | 7.2E−8 | 1.2E−6 | 4.3E−8 | 2.9E−8 | 7.1E−7 | 2.1E−7 | 3.1E−8 | 6.7E−7 | 2.5E−7 |

| | Bolt tightening torque [kgf · cm] | | | | | | |
|---|---|---|---|---|---|---|---|
| Test | 25 | | | 30 | | | |
| sample | A | B | C | A | B | C | Judgement |
| NO. 1 | 4.6E−6 | 7.6E−6 | 7.6E−6 | 4.6E−6 | 2.6E−6 | 5.6E−6 | X |
| NO. 2 | — | — | — | 1E−8 | 1E−6 | 1E−8 | X |
| NO. 3 | 7.6E−6 | 7.6E−6 | 7.6E−6 | 2.1E−8 | 5.1E−8 | 3.8E−8 | X |

Next, the gasket-integrated ceramic orifice plate used in the test was disassembled to conduct magnified observation with a microscope as well as SEM observation of the sealing part for finding causes of the high level of leakage confirmed in the test. Result of the observations indicated that the high level of leakage was mainly due to low polishing precision of the fitting protrusions 2b of the third orifice base A, the fitting recesses 3b of the fourth and fifth orifice bases B1 and B2, and the outer surfaces of the ceramic orifice plate 4 as well as presence of pits on the polished surfaces of ceramic orifice plate 4.

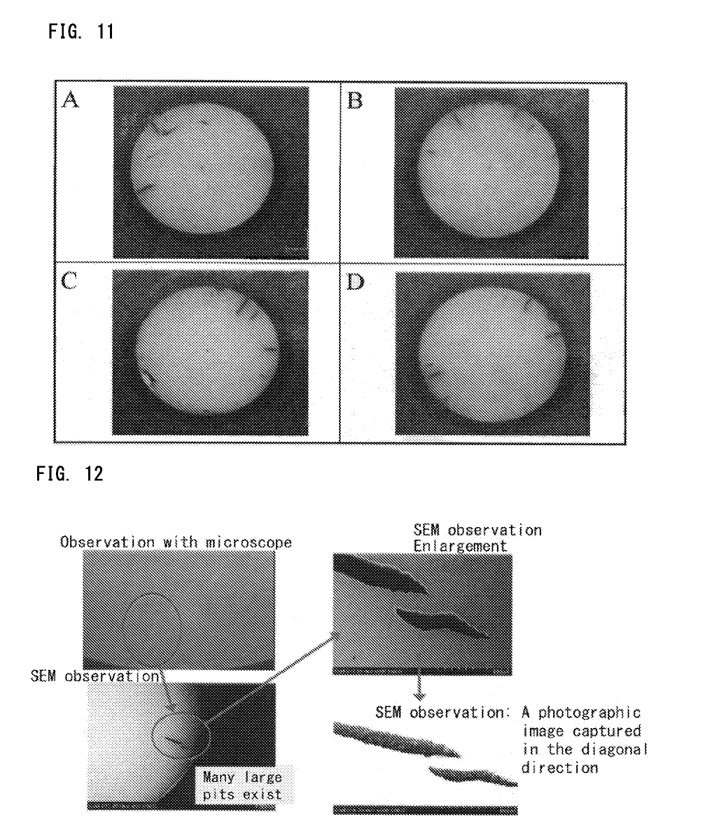

From FIGS. 9 and 10 that show the end face of one of the fitting protrusions 2b of the third orifice base A as well as the bottom face of one of the fitting recesses 3b of the fourth and fifth orifice bases B1 and B2 that abut the ceramic orifice plate 4, it became clear that polishing failure of those end faces causes the high level of leakage FIGS. 11 and 12 also show a state of the outer surface of the ceramic orifice plate 4 and it became clear that pits that originally presented on the ceramic orifice plate 4 caused the high level of leakage. As also clearly shown in FIG. 12, the pits were quite deep, and it was found that many of those were difficult to be perfectly removed even the polishing precision was enhanced.

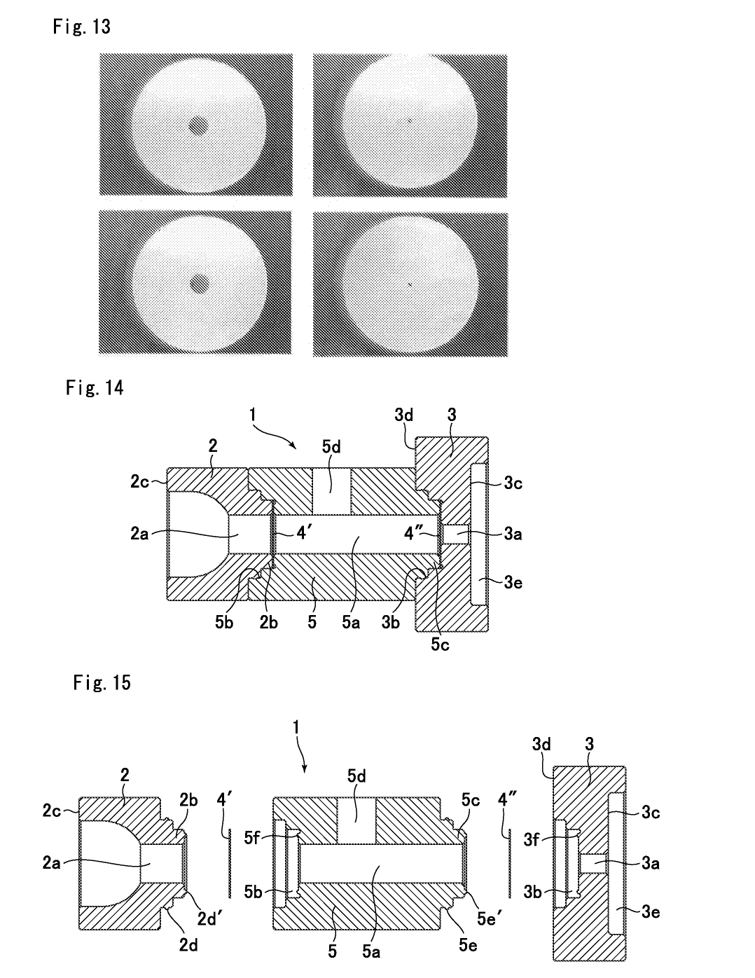

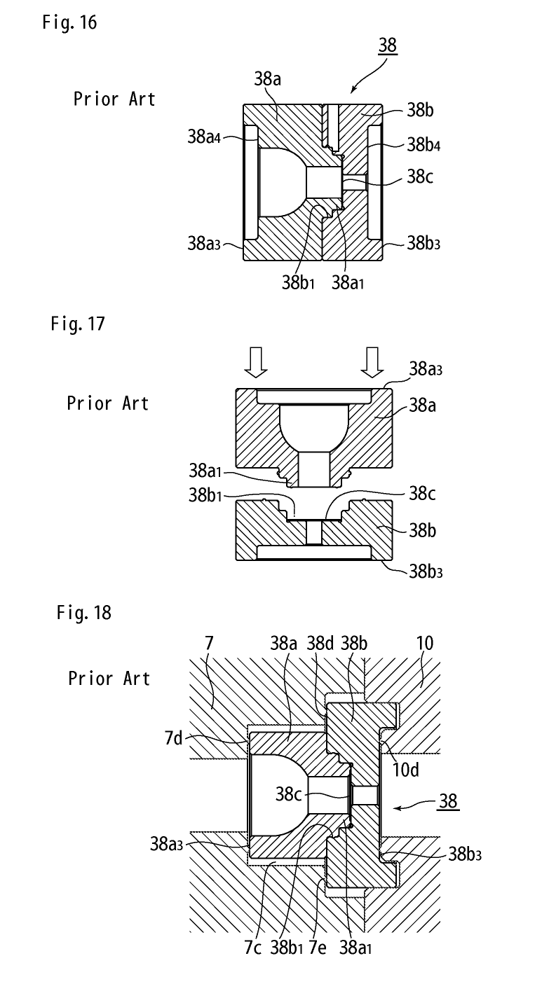

Therefore, the inventors decided to finish inner and outer surfaces of fitting protrusion 2b of a first orifice base 2 as well as a fitting recess 3b of a second orifice base 3 to mirror-polished by electro-polishing or the like. As for a ceramic orifice plate 4, lapping-polishing or the like is applied to finish outer surfaces thereof to mirror-polished, and then magnification observation by a microscope or the like is additionally conducted to check for the pits left to select and use the ceramic orifice plate 4 without pits. FIG. 13 shows a surface of the ceramic orifice plate 4 selected after the magnification observation for pits.

Below Table 2 shows results of a leakage test conducted to gasket-integrated ceramic orifice plates for testing that respectively included the first and second orifice bases 2 and 3 that were subject to mirror-polishing and the selected ceramic orifice plate 4 that was subject to mirror-polishing and checked for pits. Here, three kinds of the gasket-integrated ceramic orifice plates used for the test respectively had the ceramic orifice plate 4 which was inserted and fixed with a press fitting force.

TABLE 2

| | Press | Bolt tightening torque [kgf * cm] | | | | | | | | |
|---|---|---|---|---|---|---|---|---|---|---|
| Test | fitting | 10 | | | 15 | | | 20 | | |
| sample | force | A | B | C | A | B | C | A | B | C |
| No. 4-1 | 8 kN | 0.2E−10 | 0.3E−10 | 0.3E−10 | 0.2E−10 | 0.3E−10 | 0.3E−10 | 0.2E−10 | 0.3E−10 | 0.3E−10 |
| No. 4-2 | | 1.9E−10 | 1.6E−10 | 1.7E−10 | 1.5E−10 | 1.6E−10 | 1.6E−10 | 1.8E−10 | 1.6E−10 | 1.6E−10 |
| No. 4-3 | | 1.1E−10 | 1.0E−10 | 1.1E−10 | 1.2E−10 | 1.2E−10 | 1.2E−10 | 1.0E−10 | 1.1E−10 | 1.1E−10 |

| | Bolt tightening torque [kgf * cm] | | | | | | |
|---|---|---|---|---|---|---|---|
| Test | 25 | | | 30 | | | |
| sample | A | B | C | A | B | C | Judgement |
| No. 4-1 | 0.2E−10 | 0.3E−10 | 0.3E−10 | 0.2E−10 | 0.3E−10 | 0.3E−10 | ◯ |
| No. 4-2 | 1.7E−10 | 1.7E−10 | 1.7E−10 | 1.8E−10 | 1.8E−10 | 1.8E−10 | ◯ |
| No. 4-3 | 1.1E−10 | 1.2E−10 | 1.1E−10 | 1.3E−10 | 1.3E−10 | 1.3E−10 | ◯ |

As clearly seen in Table 2, all of the gasket-integrated ceramic orifice plates for testing turned out to be eligible for practical use since the leakage levels of those were stable and fell within an allowable range.

### Third Embodiment

FIGS. 14 and 15 illustrate a gasket-integrated ceramic orifice plate as a third embodiment according to the present invention that has almost the same configuration as that of the gasket-integrated orifice plates as a first and second embodiments shown in FIGS. 1 to 4 except that a middle orifice base 5 is used in the third embodiment.

The gasket-integrated ceramic orifice plate 1 as the third embodiment according to the present invention includes a first orifice base 2 that is provided with a penetrating passage 2a at a center thereof and that has a fitting protrusion 2b on an internal end face thereof, a second orifice base 3 that is provided with a penetrating passage 3a at a center thereof and that has a fitting recess 3b on an internal end face thereof, a middle orifice base 5 that is provided with a penetrating passage 5a at a center thereof and that has a fitting recess 5b on an end face thereof as well as a fitting protrusion 5c on the other end face thereof, and the first and second ceramic orifice plates 4′ and 4″respectively for lower flow rates and higher flow rates that respectively have an orifice at a center thereof. Here, the first orifice base 2, the middle orifice base 5, and the second orifice base 3 are fit together with the first orifice plate 4′ airtightly inserted and fixed between the first orifice base 2 and the middle orifice base 5 as well as the second orifice plate 4″ airtightly inserted and fixed between the second orifice base 3 and the middle orifice base 5, and external end faces of the both first and second orifice bases 2 and 3 as well as the internal end face of the second orifice base 3 respectively made to be sealing faces 2c, 3c, and 3d for preventing leakages at sealing locations of the both first and second orifice plates 4′ and 4″. In FIG. 15, reference symbols 2d′, 3f, and 5f designate annular protrusions.

The gasket-integrated ceramic orifice plate 1 is configured to have a plurality of flow rate adjusting ranges by forming a branched divided flow passage 5d on the middle orifice base 5 that communicates with the passage 5a of the middle orifice base 5 with the first ceramic orifice plate 4′ for lower flow rates airtightly inserted and fixed between the first orifice base 2 and the middle orifice base 5 as well as the second ceramic orifice plate 4″ for higher flow rates inserted and fixed between the second orifice base 3 and the middle orifice base 5.

Specifically, as shown in FIG. 15 the first orifice base 2 is made from stainless steel material (SUS316L-P (double melt)) and formed into a short cylindrical shape with a vertical cross section of a projecting shape, and the penetrating passage 2a with a stepped inner circumferential face is formed at the center thereof. The cylindrical-shaped fitting protrusion 2b with a stepped outer circumferential face is projectingly formed concentrically with the passage 2a on the internal end face of the first orifice base 2 (an end face against the middle orifice base 5). Here, annular protrusions 2d and 2d′ that exert sealing property when the first orifice base 2 is combined with the middle orifice base 5 are respectively formed on an outer circumferential face of a larger-diameter side of the fitting protrusion 2b as well as on an end face of the fitting protrusion 2b. Furthermore, an annularly-shaped external end face of the first orifice base 2 functions as the sealing face 2c of the gasket-integrated ceramic orifice plate 1.

As shown in FIG. 15, the second orifice base 3 is made from stainless steel material (SUS316L-P (double melt)) and formed into a recessed thick disk-shape with a vertical cross section of a recessing shape, and the penetrating passage 3a is formed at the center thereof. The fitting recess 3b in which the fitting protrusion 5c of the middle orifice base 5 is airtightly fit is formed concentrically with the passage 3a on the internal end face of the recessed second orifice base 3. An inner circumferential face of the fitting recess 3b is formed to have a stepped part so that the fitting protrusion 5c of the middle orifice base 5 is airtightly fit thereto.

A circle-shaped recess 3e is further formed concentrically with the passage 3a on the external end face of the recessed second orifice base 3, and a bottom face of the recess 3e formed on the external end face of the recessed second orifice base 3 functions as the sealing face 3c of the gasket-integrated ceramic orifice plate 1. The recess 3e facilitates positioning (shaft alignment) of the gasket-integrated ceramic orifice plate 1 and protects the sealing face 3c.

As shown in FIG. 15, the middle orifice base 5 is made from stainless steel material (SUS316L-P (double melt)) and formed into a cylindrical shape with the same diameter dimension as an outer diameter dimension of the first orifice base 2, and the penetrating passage 5a that communicates with the passage 2a of the first orifice base 2 as well as the passage 3a of the second orifice base 3 is formed at a center thereof. The fitting recess 5b in which the fitting protrusion 2b of the first orifice base 2 is airtightly fit is formed concentrically with the passage 5a on an end face of the middle orifice base 5. An inner circumferential face of the fitting recess 5b is formed to have a stepped part so that the fitting protrusion 2b of the first orifice base 2 is airtightly fit thereto.

Furthermore, the cylindrical-shaped fitting protrusion 5c with a stepped outer circumferential face that is airtightly fit to the fitting recess 3b of the second orifice base 3 is projectingly formed concentrically with the passage 5a on the other end face of the middle orifice base 5. Here, annular protrusions 5e and 5e′ that exert sealing property when the middle orifice base 5 is combined with the second orifice base 3 are respectively formed on an outer circumferential face of a larger-diameter side of the fitting protrusion 5c as well as an end face of the fitting protrusion 5c. Further, a branched divided flow passage 5d that communicates with the passage 5a of the middle orifice base 5 is formed on a peripheral wall of the middle orifice base 5.

The first ceramic orifice plate 4′ for lower flow rates and the second ceramic orifice plate 4″ for higher flow rates are of course made from the same material and formed into the same shape as in the first and second embodiments, and an outer shape of the both first and second orifice plates 4′ and 4″ may be good in a form of a circle or any other shape.

The gasket-integrated ceramic orifice plate according to the present invention has excellent corrosion-resistance achieved by a ceramic orifice plate used therein, has a stable flow rate control characteristic obtained even in a flow passage for a corrosive gas, and secures good airtightness between the ceramic orifice plate and a metal end face that offers enough sealing level for practical use, and those all contribute to a superior practical effect.

### INDUSTRIAL APPLICABILITY

The present invention is applicable not only to a pressure-type flow rate control system, but also to any pipes and/or devices used for corrosive liquids.

### REFERENCE SIGNS LIST

1 Gasket-integrated ceramic orifice plate
2 First orifice base
2a Passage of the orifice base
2b Fitting protrusion of the orifice base
2c Sealing face of the orifice base
2d Annular protrusion
2d′ Annular protrusion
3 Second orifice base
3a Passage of the orifice base
3b Fitting recess of the orifice base
3c Sealing face of the orifice base
3d Sealing face of the orifice base
3e Recess
3f Annular protrusion
4 Ceramic orifice plate
4′ First ceramic orifice plate for lower flow rates
4″ Second ceramic orifice plate for higher flow rates
5 Middle orifice base
5a Passage of the middle orifice base
5b Fitting recess of the middle orifice base
5c Fitting protrusion of the middle orifice base
5d Divided flow passage of the middle orifice base
5e Annular protrusion
5e′ Annular protrusion
5f Annular protrusion
6 Control valve
7 Control valve body
7a Flow passage
7b Flow passage
7c Orifice housing recess
7d Annular protrusion
7e Annular protrusion
8 Inlet-side block
9 Filter
10 Outlet-side block
10a Passage
10b Orifice housing recess
10c Gasket holding protrusion
10d Annular protrusion
11 Pressure sensor
12 Control circuit
A Third orifice base
B1 Fourth orifice base
B2 Fifth orifice base
C Leakage detecting hole
D Leakage detecting hole
E Leakage detecting hole
L Leakage testing tool

What is claimed is:

1. A gasket-integrated ceramic orifice plate comprising:
a first orifice base provided with a fitting protrusion and a penetrating passage through a center;
a second orifice base provided with a fitting recess and a penetrating passage communicating with the passage of the first orifice base through a center;
a ceramic orifice plate airtightly inserted and fixed between end faces of the first and second orifice bases, and wherein
respective external end faces of the first and the second orifice bases are made to be sealing faces of the gasket.

2. The gasket-integrated ceramic orifice plate according to claim 1, wherein
one of the first and second orifice bases is configured to have a larger outer diameter than an outer diameter of the other orifice base, and an outer circumferential edge of an internal end face of the orifice base with the larger outer diameter is made to be a sealing face.

3. The gasket-integrated ceramic orifice plate according to claim 1, wherein
the ceramic orifice plate has an orifice at a center thereof that communicates with the passages of the first and second orifice bases and that is airtightly inserted and fixed between the fitting protrusion of the first orifice base and the fitting recess of the second orifice base.

4. The gasket-integrated ceramic orifice plate according to claim 3, wherein
the ceramic orifice plate is zirconia-contained ceramic made and is 500 to 1000 μm in thickness, and the orifice diameter is 10 to 500 μm in dimension, and the fitting protrusion is pressed into the fitting recess with a press fitting force of 6 to 10 kN to airtightly insert and fix the ceramic orifice plate between the fitting protrusion and the fitting recess.

5. The gasket-integrated ceramic orifice plate according to claim 4, wherein
both sides of the circle-shaped ceramic orifice plate are mirror-polished and contacting faces of the fitting protrusion and the fitting recess that abut the ceramic orifice plate are also mirror-polished.

6. A gasket-integrated orifice plate comprising:
a first orifice base that has a fitting protrusion on an internal end face thereof and that is provided with a penetrating passage at a center thereof;
a second orifice base that has a fitting recess on an internal end face thereof and that is provided with a penetrating passage at a center thereof;
a middle orifice base that is provided with a penetrating passage at a center thereof that communicates with the passages of the first and second orifice bases and that has a fitting recess on an end face thereof in which the fitting protrusion of the first orifice base is airtightly fit as well as a fitting protrusion on another end face thereof to which the fitting recess of the second orifice base is airtightly fit;
a first ceramic orifice plate that is airtightly inserted and fixed between the first orifice base and the middle orifice base and that has an orifice formed at a center thereof; and
a second ceramic orifice plate that is airtightly inserted and fixed between the middle orifice base and the second orifice base and that has an orifice formed at a center thereof,
wherein the gasket-integrated ceramic orifice plate is provided in a liquid flow passage with external end faces of the first and second orifice bases made to be sealing faces, an outer diameter dimension of one of the first or second orifice bases is configured to be larger than outer diameter dimensions of the other orifice base and the middle orifice base with an outer circumferential edge of an internal end face of the orifice base with the larger outer diameter made to be a sealing face, and a divided flow passage that communicates with the passage of the middle orifice base is formed on the middle orifice base.

7. The gasket-integrated ceramic orifice plate according to claim 6, wherein
the first ceramic orifice plate has an orifice at a center thereof that communicates with the passage of the first orifice base as well as the passage of the middle orifice base and is airtightly inserted and fixed between the fitting protrusion of the first orifice base and the fitting recess of the middle orifice base.

8. The gasket-integrated ceramic orifice plate according to claim 6, wherein
the second ceramic orifice plate has an orifice at a center thereof that communicates with the passage of the middle orifice base as well as the passage of the recessed second orifice base and is airtightly inserted and fixed between the fitting protrusion of the middle orifice base and the fitting recess of the recessed second orifice base.

9. The gasket-integrated ceramic orifice plate according to claim 7, wherein
the first ceramic orifice plate is zirconia-contained ceramic made and is 500 to 1000 μm in thickness, and the orifice diameter is 10 to 500 μm in dimension, and the fitting protrusion of the first orifice base is pressed into the fitting recess of the middle orifice base with a press fitting force of 6 to 10 kN to airtightly insert and fix the first ceramic orifice plate between the fitting protrusion of the first orifice base and the fitting recess of the middle orifice base.

10. The gasket-integrated ceramic orifice plate according to claim 8, wherein
the second ceramic orifice plate is zirconia-contained ceramic made and is 500 to 1000 μm in thickness, and the orifice diameter is 10 to 500 μm in dimension, and the fitting protrusion of the middle orifice base is pressed into the fitting recess of the second orifice base with a press fitting force of 6 to 10 kN to airtightly insert and fix the second ceramic orifice plate between the fitting protrusion of the middle orifice base and the fitting recess of the second orifice base.

11. The gasket-integrated ceramic orifice plate according to claim 6, wherein
a diameter dimension of the orifice of one of the first and second orifice plates that positions at an upstream-side is configured to be smaller than a diameter dimension of the orifice of the another orifice plate that positions at a downstream-side.

12. The gasket-integrated ceramic orifice plate according to claim 6, wherein
both sides of the first and second circle-shaped ceramic orifice plates are mirror-polished, and contacting faces of the fitting protrusion of the first orifice base and the fitting recess of the second orifice base that abut the first and second ceramic orifice plates are mirror-polished as well.

13. A gasket-integrated ceramic orifice plate comprising:
a third orifice base that has fitting recesses on both side faces thereof and that is provided with a penetrating passage at a center thereof;
fourth and fifth orifice bases that respectively have a fitting protrusion, that are respectively provided with a penetrating passage at a center thereof, and that are respectively inserted into the each fitting recess opposingly; and
a ceramic orifice plate that is arranged in the passage of the third orifice base,
wherein the ceramic orifice plate arranged in the passage of the third orifice base is airtightly clamped and fixed between tip faces of the fourth and fifth orifice bases that are pressed into the fitting recesses with external end faces of the fourth and fifth orifice bases made to be sealing faces of the gasket.

14. The gasket-integrated ceramic orifice plate according to claim 13, wherein
annular protrusions are formed on outer circumferential faces as well as on the tip faces of the fitting protrusions of the fourth and fifth orifice bases to enhance airtightness between the fitting protrusions and the fitting recesses by the annular protrusions on the outer circumferential faces of the fitting protrusions and to enhance airtightness between the fitting protrusions and the ceramic orifice plates by the annular protrusions on the tip faces of the fitting protrusions.

15. The gasket-integrated ceramic orifice plate according to claim 13, wherein
the ceramic orifice plate is thick disk-shaped and made of zirconia-contained ceramic, and the both fitting protrusions are pressed into the both fitting recesses with a press fitting force of 6 to 10 kN to airtightly insert and fix the ceramic orifice plate between the tip faces of the both fitting protrusions.
